(19) United States
(12) Patent Application Publication
(10) Pub. No.: US 2007/0116952 A1
(43) Pub. Date: May 24, 2007

(54) Elongated cross section elastic fibers for stable packages

(75) Inventors: Ashish Sen, Lake Jackson, TX (US); Selim Bensason, Houston, TX (US); Angus W. Cheng, Tsing Yi (HK)

Correspondence Address: THE DOW CHEMICAL COMPANY, INTELLECTUAL PROPERTY SECTION,, P. O. BOX 1967, MIDLAND, MI, 48641-1967, US

(73) Assignee: DOW GLOBAL TECHNOLOGIES INC., Midland, MI (US)

(21) Appl. No.: 10/578,547

(22) PCT Filed: Nov. 30, 2004
(86) PCT No.: PCT/US04/40035

§ 371 Date: May 5, 2006

Related U.S. Application Data
(60) Provisional application No. 60/526,629, filed on Dec. 3, 2003.

(51) Int. Cl. B29C 47/12; D02G 3/02

(52) U.S. Cl. 428/394; 264/177.13

(57) ABSTRACT

An improved process for winding an elastic fiber onto a core for forming a package and/or warp beam for use in knitting or weaving operations is disclosed. The improvement comprises forming the elastic fiber into a shape having a fiber cross section such that the width of the fiber is at least three times the thickness of the fiber prior to winding the fiber onto the supply package. Another aspect of the invention involves forming elastic fiber using a extrusion melt spinning process with a die having one or more openings which have two generally perpendicular axes, wherein one axis is at least about 1.5, preferably at least about 3 times longer than the other axis. The fiber of the present invention having the elongated cross section can be used to make improved supply packages for knitting or weaving fabric and also for making improved nonwoven structures and improved binder fibers.

The present invention relates to a supply package for elastic fiber intended for use with various types of textile producing equipment. The package is formed using elastic fiber which has an elongated cross-sectional area. The invention also relates to an improved process for winding elastic fiber onto a tube core to minimize sloughing and breaks during unwinding, characterized in that the elastic fiber is formed into a shape having an elongated cross section prior to winding.

Elastic fiber such as spandex or lastol is well known and widely used in textile production. In producing elastic fibers for use in textiles, the fiber is typically wound onto tube cores. The wound fiber is known in the textile industry as a package, cake or bobbin. The package, which may be further processed prior to use, facilitates the use of the fiber in textile production, by allowing the fiber to be unwound and fed to downstream processes. Alternatively, the fiber may be wound directly onto a warp beam, which can then be used directly as the supply package in the textile production process. The fiber is unwound using either a passive or an active feeding device. An active feeding device removes the fiber from the supply package while the package is rotated by some mechanical means, such as a surface-contacting driven roller or a driven rotation of the tube core on which the fiber was wound. A passive feeding device removes the fiber from the package by pulling the fiber itself, such as by over one end of the package (“over-end take-off”) or by pulling the fiber tangentially from the surface of the package and allowing the package to rotate on its tubular axis.

Prior packages for elastic fiber suffer from fiber sliding or falling down from the package surface (“sloughing”), during processing, handling, storage or use of the package. Sloughing leads to breaks due to fiber entanglement, which increases waste and decreases manufacturing speed, and can produce inferior yarns and fabric.

Accordingly it is a goal of elastic fiber producers to produce packages which exhibit reduced amounts of sloughing. Prior methods of reducing sloughing have typically involved the optimization of the winding variables or the optimization of the spin finish type and content. For example WO0/61484 teaches reducing the contact force toward the end of winding, while U.S. Pat. No. 5,560,558 and JP 9301632 teach reducing the spin finish level in the last portion of winding. In contrast, WO00/78658 teaches an increased level of finish in the last portion of unwinding. JP 6316373 and JP2233471 teach a reduction in deposited yarn width on the surface of the packages while JP 2001130832 teaches a reduced width at start-up and subsequent increase in width, to improve package formation and unwinding. JP99180643 teaches using an S-shaped variation in helix angle during winding. U.S. Pat. No. 6,086,004 teaches application of variable winding speeds or stretch ratios.

Implementation of these known solutions all require hardware modifications which add expense and complexity to the process. Further, the techniques considered above have been observed to decrease sloughing only marginally. Accordingly, there is still a need for improved techniques for producing packages which are resistant to sloughing, especially techniques which do not add substantial hardware modifications.

Additionally, it has been observed that soft stretch elastic fibers based on ethylene copolymers do not have a strong tendency to stick and therefore the package cohesion is generally lower than for spandex fibers. Lower cohesion leads to slip of fibers on the surface when brought into rubbing contact. This in turn may lead to formation of surface loops in tractive unwinding.

It has been discovered that by forming the elastic fiber such that it has elongated cross sections results in increased fiber to fiber cohesion while maintaining acceptable fiber release properties in unwinding. Ideally the elastic fiber is formed into a shape having a cross section such that the width (or long axis) of the fiber's cross section is at least 1.5, preferably at least 3 times the thickness (or short axis) of the fiber's cross section, such shape being determined prior to winding the elastic fiber onto the core.

Accordingly, the present invention relates to a process for winding an elastic fiber onto a supply package such as a tube core for use in knitting or weaving operations, the improvement comprising: forming the elastic fiber into a shape having a cross section such that the width of the fiber is at least 1.5, preferably at least 3 times the thickness of the fiber, such shape being determined prior to winding the elastic fiber onto the supply package.

The present invention also relates to an improved package for elastic fiber comprising: a length of elastic fiber wound around a core, wherein the elastic fiber has a cross sectional area such that the width of the fiber is at least 1.5, preferably at least 3 times the thickness of the fiber prior to winding the elastic fiber onto the tube core.

In another aspect of the present invention, an improved process for making extruded fiber is disclosed wherein the improvement comprises using a die having one or more openings which have two generally perpendicular axes, wherein one axis is at least about 1.5, preferably at least 3 times longer than the other axis.

The resulting fiber having an elongated cross-section can be used to make improved supply packages for woven or knitted fabrics or it may also be advantageously used in a nonwoven structure or as a binder fiber.

The present invention relates to a process for winding a monofilament elastic fiber onto a core for forming a supply package for use in knitting or weaving operations, the improvement comprising: forming the elastic fiber into a shape having a cross section such that the width of the fiber's cross section is at least 1.5, preferably at least 3 times the thickness of the fiber's cross section.

For purposes of this invention, the term “fiber” means a material in which the length to diameter ratio is greater than about 10. Fiber is typically classified according to its diameter. “Filament fiber” or “monofilament fiber” means a single, continuous strand of material of indefinite (that is, not predetermined) length, as opposed to a “staple fiber” which is a discontinuous strand of material of definite length (that is, a strand which has been cut or otherwise divided into segments of a predetermined length.

For purposes of the invention, the term “elastic” means that a fiber will recover at least about 50 percent of its stretched length after the first pull and after the fourth to 100% strain (doubled the length). Elasticity can also be described by the “permanent set” of the fiber. Permanent set is the converse of elasticity. A fiber is stretched to a certain point and subsequently released to the original position before stretch, and then stretched again. The point at which the fiber begins to pull a load is designated as the percent permanent set. An “elastic” fiber will have a permanent set less than 50%. “Elastic materials” are also referred to in the art as “elastomers” and “elastomeric”.

“Homofil fiber” means a fiber that has a single polymer region or domain over its length, and that does not have any other distinct polymer regions (as does a bicomponent fiber). “Bicomponent fiber” means a fiber that has two or more distinct polymer regions or domains over its length. Bicomponent fibers are also known as conjugated or multicomponent fibers. The polymers are usually different from each other although two or more components may comprise the same polymer. The polymers are arranged in substantially distinct zones across the cross-section of the bicomponent fiber, and usually extend continuously along the length of the bicomponent fiber. The configuration of a bicomponent fiber can be, for example, a cover/core (orsheath/core) arrangement (in which one polymer is surrounded by another), a side by side arrangement, a pie arrangement or an “islands-in-the sea” arrangement. Bicomponent fibers are further described in U.S. Pat. Nos. 6,225,243, 6,140,442, 5,382,400, 5,336,552 and 5,108,820.

“Meltblown fibers” are fibers formed by extruding a molten thermoplastic polymer composition through a plurality of fine, die capillaries as molten threads or filaments into converging high velocity gas streams (for example, air) which function to attenuate the threads or filaments to reduced diameters. The filaments or threads are carried by the high velocity gas streams and deposited on a collecting surface to form a web of randomly dispersed fibers with average diameters generally smaller than 10 microns.

“Meltspun fibers” are fibers formed by melting at least one polymer and then drawing the fiber in the melt to a peripheral shape which is less than the peripheral shape of the die.

“Spunbond fibers” are fibers formed by extruding a molten thermoplastic polymer composition as filaments through a plurality of fine, die capillaries of a spinneret. The diameter of the extruded filaments is rapidly reduced, and then the filaments are deposited onto a collecting surface to form a web of randomly dispersed fibers with average diameters generally between 7 and 30 microns.

“Nonwoven” means a web or fabric having a structure of individual fibers or threads which are randomly interlaid, but not in an identifiable manner as is the case of a knitted fabric. The elastic fiber of the present invention can be employed to prepare nonwoven structures as well as composite structures of elastic nonwoven fabric in combination with nonelastic materials.

The elastic fiber of the present invention can be any known fiber meeting the definition of elastic given above, including spandex fiber. Such fibers include ethylene polymers, propylene polymers and fully hydrogenated styrene block copolymers (also known as catalytically modified polymers), and blends or combinations thereof. The ethylene polymers include the homogeneously branched and the substantially linear homogeneously branched ethylene polymers as well as ethylene-styrene interpolymers. These fibers are well known in the art, for example many of these are disclosed in U.S. Pat. No. 6,437,014. As described in that reference, the fibers can be formed by many processes known in the art, for example the fibers can be melt spun, gel spun, meltblown, or spunbonded. The elastic fibers of the present invention are preferably crosslinked, heat-resistant olefin elastic fibers such as lastol. The most preferred elastic fiber for use in the present invention is melt spun fiber made from ethylene-alpha olefin interpolymers, particularly substantially linear polyethylene which has been substantially crosslinked.

The elastic fiber of the present invention preferably is greater than 15 denier, more preferably greater than bout 70 denier. The elastic fiber of the present invention can be characterized by having a generally elongated cross section, such that the width of the cross section is at least about three times the thickness of the cross section.

Without intending to be bound by theory, it is believed that the reason for improved fiber cohesion and subsequent improvements in supply package formation and unwinding appear to be a consequence of increased area of surface contact attained by the elongated fiber cross-sections. The more ribbon-like geometry leads to preferential deposition parallel to the long axis which leads to an increased surface area for the surface contact between adjacent layers of fibers. The increased contact decreases the chance of movement or sloughing during storage and handling.

Thus, any cross-sectional shape which maximizes the surface contact between adjacent layers of fiber is suitable for use with the present invention. For practical reasons, the fiber for use in the present invention typically has a cross-sectional shape which is generally rectangular or oval but any other shape which can be characterized as having a long axis and a short axis which are generally perpendicular to each other will be suitable. The cross sectional area of the fibers are such that the width (or long axis) of the fiber is at least one and a half, more preferably at least two times the thickness (or short axis) of the fiber, still more preferably at least three times the thickness of the fiber. Preferably, the width is less than about ten times more preferably less than about five times the thickness of the fiber, as at higher aspect ratios excessive cohesion may be observed and cause additional problems. It is preferred that the dimensions of the fiber's cross-section be determined when the fiber is not on the core, most preferably prior to winding the elastic fiber onto the core. For most fibers, the two axes will be readily identifiable from a cross sectional view of the fiber which can be obtained using microscopy or other methods generally known in the art. The lengths of the short and long axis can be easily measured from the cross-section to determine whether it meets the criteria of the present invention. Generally the maximum lengths of the axes are used to determine whether it meets the criteria of the present invention, but in some non-uniform shapes

Fiber having a suitable cross-sectional shape can be formed in any way known to the art, and the particular method used is not critical to the present invention. For example, the shape of the openings in the die used to extrude the polymer may be configured so as to produce the desired shape fiber. Further the extrusion conditions, and the rheology of the polymer being extruded may be manipulated to promote more or less rounding. In order to maximize the surface to surface contact area, less rounding is generally preferred. It is also possible to physically shape the fiber while it is still in a semi-molten condition. It is also possible to provide smaller denier filaments (including those with a circular cross-section) arranged side-by-side in close proximity with each other and allow them to coalesce such that the resulting fiber has an aspect ratio within the scope of the present invention. In situations where solvent removal during extrusion is desired, this may be a preferred method. It may also be possible to form fibers having the desired cross-section by first forming a film of appropriate thickness and then slitting the film to form fibers having the desired width.

The present invention can be used with all known winding systems which can be optimized as is known in the art. Optimization of winding includes things such as adjusting the draw ratio between Godet rolls and winder, adjusting the helix angle and adjusting the friction roll contact pressure. Similarly, spin finish type and content may also be optimized in combination with the present invention as is known in the art.

The present invention also relates to an improved supply package for elastic fiber comprising: a length of elastic fiber wound around a core, wherein the elastic fiber has a cross section such that the width of the fiber is at least 1.5, preferably at least 3 times the thickness of the fiber prior to winding the elastic fiber onto the tube core. The package will exhibit fewer breaks than a similar package of fiber having a round cross-section and similar denier under the same processing conditions.

Another aspect of the present invention is an improved process for making extruded fiber wherein the improvement comprises using a die having one or more openings which have two generally perpendicular axes, wherein one axis is at least about three times longer than the other axis. It is preferred that the die is a spinneret comprising a plurality of openings substantially all of which have the geometry described above. It is also preferred that the longer axis be more than about four times as long as the shorter axis, and most preferably about five times as long.

In addition to making improved supply packages for use in the production of woven or knitted fabric, the fiber having an elongated cross section can also be used to make improved nonwoven structures, and improved binder fibers. It is believed that the increase in surface area exhibited by the fiber which helps reduce sloughing in supply packages, will also provide an increased number of contact points for binding, resulting in a more coherent nonwoven structure.

What is claimed is:

1) In a process for winding an elastic fiber onto a core for forming a package and/or warp beam for use in knitting or weaving operations, the improvement comprising: forming the elastic fiber into a shape having a fiber cross section such that the width of the fiber is at least 1.5 times the thickness of the fiber, prior to winding onto the core.

2) The process of claim 1 wherein the width of the cross-sectional area is at least 3 times the thickness of the fiber.

3) The process of claim 1 wherein the width of the cross-sectional area is at least 5 times the thickness of the fiber.

4) The process of claim 1 wherein the elastic fiber is an olefin polymer.

5) The process of claim 1 wherein the elastic fiber is a linear ethylene-alpha olefin interpolymer.

6) The process of claim 1 wherein the elastic fiber is a substantially linear ethylene-alpha olefin interpolymer which has been substantially crosslinked.

7) The process of claim 1 wherein the fiber is formed using dies having an opening which has two generally perpendicular axes, wherein one axis is at least about 1.5 times longer than the other axis.

8) The process of claim 1 wherein the fiber is formed using dies having an opening which has two generally perpendicular axes, wherein one axis is at least about 3 times longer than the other axis.

9) The process of claim 1 wherein the fiber is formed from two or more individual filaments having a generally round cross-section but wherein the two or more filaments are coalesced into a fiber having a cross section such that the width of the fiber is at least 3 times the thickness of the fiber, such shape being determined prior to winding the elastic fiber onto the tube core.

10) An improved package for elastic fiber comprising: a length of elastic fiber wound around a core, wherein the elastic fiber has a cross sectional area such that the width of the fiber is at least 3 times the thickness of the fiber prior to winding the elastic fiber onto the tube core

11) A process for forming an elastic fiber wherein the fiber is formed using a die having one or more openings which have two generally perpendicular axes, wherein one axis is at least about 3 times longer than the other axis.

12) The process of claim 11 wherein the fiber is used in a nonwoven structure

13) The process of claim 11 wherein the fiber is used as a binder fiber.

14) The process of claim 13 wherein the binder fiber is a bicomponent fiber.

15) The process of claim 11 wherein the fiber is wound onto a package or warp beam.

16) Fabric comprising a fiber made from the process of claim 11.

17) The Fabric of claim 16 wherein the fabric is woven or knitted.
